(19) United States
(12) Patent Application Publication
(10) Pub. No.: US 2004/0203398 A1
(43) Pub. Date: Oct. 14, 2004

(54) Rapid channel characterization for bluetooth co-existence

(76) Inventor: Randolph L. Durrant, Colorado Springs, CO (US)

Correspondence Address: John P. Ward, Blakely, Sokoloff, Taylor & Zafman LLP, Seventh Floor, 12400 Wilshire Boulevard, Los Angeles, CA, 90025-1030, US

(21) Appl. No.: 10/262,280

(22) Filed: Sep. 30, 2002

(51) Int. Cl. H04B 5/00; H04B 1/10

(52) U.S. Cl. 455/63.1; 455/41.2

(57) ABSTRACT

In one embodiment, the invention provides a method comprising performing a channel assessment of predefined communications channels, each centered on a particular frequency within a frequency band, the channel assessment comprising determining if interference on each predefined channel is above a predefined energy threshold, wherein the predefined communications channels are visited in a predefined sequence in which those predefined channels in which interference from specific types of interferers known to operate in the frequency band is likely are visited first. The method also comprises disabling those communications channels on which interference above the predefined energy threshold is detected.

### FIELD OF THE INVENTION

This invention relates to wireless communications. In particular it relates to avoiding interference in a Bluetooth compliant device.

### BACKGROUND

Bluetooth is a wireless protocol used by wireless local area networks (WLANs) operating in the 2.4 GHz (2.4 to 2.483 GHz) unlicensed radio frequency (RF) industrial scientific and medical (ISM) band. Bluetooth uses 79, 1 MHz wide channels in the 2.4 GHz band.

In order to avoid interference from other devices operating in the 2.4 GHz band, Bluetooth uses a channel hopping method to hop over the 79 channels. Thus, on average Bluetooth devices occupy a 79 MHz bandwidth, but at any given moment each device only occupies a 1 MHz bandwidth. Each of the channel hops goes to a slot that is 625 microseconds long, (packets will last between 1, 3, or 5 slots, but the hop frequency remains the same for each packet). The hopping sequence allows multiple Bluetooth piconets (networks) to coexist simultaneously.

However, the 2.4 GHz band may be populated with signals from other known compliant devices that may be operating in the 2.4 GHz band. If the signals are of the same frequency as a Bluetooth channel then they will interfere with the Bluetooth signals on the Bluetooth channel and may be of sufficient duration and strength to cause packet losses on the Bluetooth channel, notwithstanding the channel hopping.

### BRIEF DESCRIPTION OF THE DRAWINGS

FIG. 1 shows a flowchart of operations performed by a receiver in accordance with one embodiment of the invention;

FIG. 2 shows one embodiment of a sequence table; and

FIG. 3 shows a high level block diagram of one embodiment of a receiver in accordance with the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

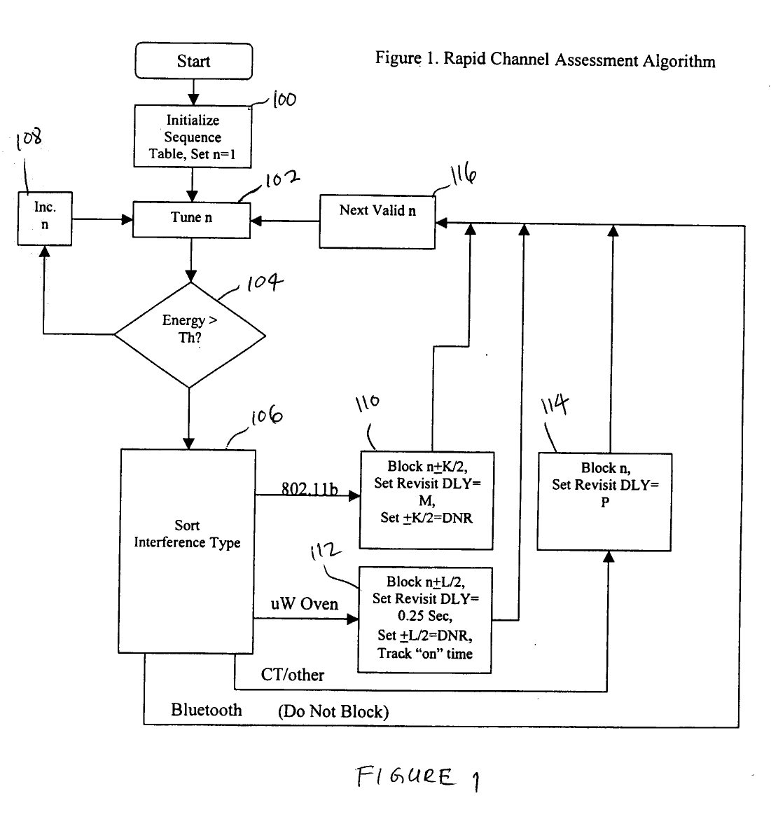

FIG. 1 of the drawings shows a flow chart of operations performed in accordance with one embodiment of the invention. The operations shown in FIG. 1 are performed by a Bluetooth receiver in order to assess interference levels on the 79 Bluetooth channels and to block those channels where the interference levels are high. (Blocking may consist of re-mapping the Bluetooth frequency hop sequence in a manner that avoids using channels classified as bad by these algorithms. The Bluetooth Special Interest Group delineates methods to re-map the frequency hop pattern in their AFH algorithm for example). In this manner packet losses due to interference from other devices operating in the 2.4 GHz band may be reduced. Thus broadly, the operation shown in FIG. 1 disclose a technique in which a channel assessment of predefined communication channels in the form of the 79, 1 MHz Bluetooth channels, each centered on a particular frequency within a frequency band (the 2.4 GHz frequency band) is performed. The channel assessment comprises determining if interference on each predefined channel is above a predefined energy threshold. The channel assessment involves visiting the predefined communication channels in a predefined sequence in which those channels in which interference from specific types of interferers know to operate in the 2.4 GHz frequency band are likely to be visited first. Thereafter, those communications channels on which interference above the predefined energy threshold is detected are disabled or avoided.

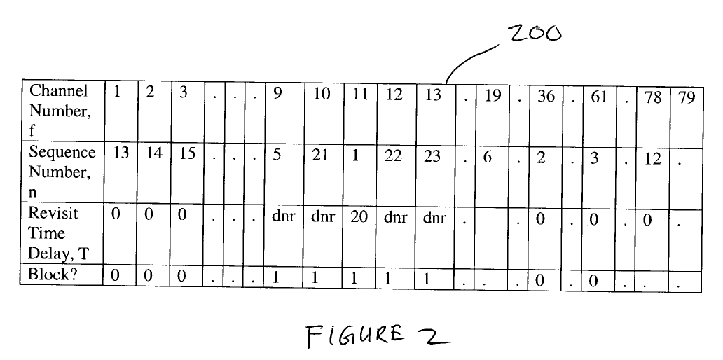

Referring to FIG. 1, at block 100 the predefined sequence is initialized which includes loading a frequency sequence table into memory and assigning a value of 1 to a counter n. FIG. 2 of the drawings shows an example of a frequency sequence table 200. The purpose of the frequency sequence table 200 is to map a sequence number n to a channel number f. Sequence numbers are integers in the range of 1 to 79 and specify an order in which the Bluetooth channel numbers f are to be visited. For example, in the case of the table 200, sequence number n=1 is assigned to channel number f=11, sequence number n=2 is assigned to channel number f=36, and sequence number n=3 is assigned to channel number f=61. Thus, the predefined sequence of visiting the 79 Bluetooth channels in the case of the table 200 comprises visiting channel 11 first, channel 36 second, channel 61 third, etc.

It turns out that Bluetooth channel 11 has a center frequency that is the same frequency of channel 1 of the WLAN protocol known as the 802.11b, channel number 36 has a center frequency which is also the center frequency of channel 6 of the 802.11b protocol, and Bluetooth channel 61 has a center frequency that is also the center frequency of 802.11b channel 11.

The 802.11b standard uses a22 MHz portion of the 2.4 GHz band. This 22 MHz portion is divided into 11 to 14 channel center frequencies depending upon the country of deployment. For example, in the US, 11 channels are used with three of them being most likely due to their non-overlapping nature. The three non-overlapping channels recommended by the Institute of Electrical and Electronic Engineers in (IEEE) in the US, are channels 1, 6, and 11.

Thus, it will be seen that the sequence table 200 shown in FIG. 2 will cause a Bluetooth device to initiate a sequence in which to visit each of the Bluetooth channels in order to perform a channel assessment in which the Bluetooth channel having a center frequency in common with 802.11b channel 1 would be visited first, the Bluetooth channel having a center frequency which coincides with the center frequency of 802.11b channel 6 which would be visited second, and the Bluetooth channel having a channel center frequency which is the same as the channel center frequency of 802.11b channel 11 would be visited third. In other words, the table 200 defines a sequence in which the 79 Bluetooth channels are to be visited, wherein the most likely 802.11b channel in use in a particular area will be visited first. The significance of this is that 802.11b interferers most likely to be operating in the 2.4 HGz band will be identified first without having to perform an exhaustive search of all channels. It will be appreciated that one advantage of the predefined search sequence shown in FIG. 2, is that it allows the rapid identification of interference caused by 802.11b interferers so that bad channels, i.e. channels on which 802.11b interference is being received above a predefined energy threshold can be rapidly eliminated from the channel hopping sequence. Thus, the rapid detection and evaluation of 802.11b interference will result in fewer packet losses and thus lower packet error rates in Bluetooth communications.

Turning again to FIG. 1 of the drawings, at 102 the Bluetooth receiver is tuned to the frequency of the Bluetooth channel assigned to the sequence number n, which in a first pass through the operation shown in FIG. 1 of the drawings, will be the channel 11. At block 104, the energy level of signals received on the tuned channel, i.e. channel 11, is measured, and if the energy level is found to be above a predefined threshold then block 106 is executed. If, however it is determined at block 104, that the energy level of the received signals on the tuned channel, i.e. channel 11, is below the predefined threshold then block 108 is executed, wherein the sequence number n is incremented. As will be seen from FIG. 1, after execution of block 108, block 102 is re-executed. In one embodiment, the predefined energy level is selected to provide a good indication of when an interference signal is present on the tuned channel. Thus, in one embodiment, the predefined energy threshold is set to be about 10 dB above the sensitivity of the Bluetooth receiver.

In block 106 operations are performed to sort the interference on the tuned channel, i.e. channel 11, by source type. In one embodiment, the source type includes 802.11b interferers, microwave ovens, and cordless telephones operating in the 2.4 GHz band. At block 110, if the interference is determined to be interference from an 802.11b source, the Bluetooth channel number f that is mapped to the sequence number n is blocked. Once blocked, a Bluetooth channel is not available for selection during channel hopping. In one embodiment, blocking the Bluetooth channel mapped to the sequence number n involves transmitting the channel to be blocked to a master unit for the particular piconet within which the Bluetooth receiver is operating.

In a further embodiment, and as an optimization to increase the speed at which “bad channels” are eliminated from selection during channel hopping, all neighboring Bluetooth channels within a range of K/2 of the Bluetooth channel mapped to the sequence number n are automatically blocked without actually visiting those channels. The value for K is set at 22 MHz which represents the maximum bandwidth of an 802.11b signal. Thus, in the case of sequence number n being 1, Bluetooth channel 11 which is mapped to sequence number n=1 (see FIG. 2 of the drawings) will be blocked. Additionally, channels 1 through 22 will also be blocked, without actually having visited those channels, since those channels are located within the range of 11 MHz from channel 11. The rationale behind blocking these channels without actually visiting them is that since an 802.11b signal can be up to 22 MHz wide, it follows that these channels could also be receiving 802.11b interference signals.

In one embodiment, the operations at block 110 further comprise setting a revisit delay after which the tuned channel corresponding to sequence number n is to be revisited. For example, in the case of table 200 of FIG. 2, it will be seen that the revisit delay for channel number 11 is set to 20 microseconds. The purpose of the revisit delay is to ensure that a particular blocked channel is revisited after the delay period in order to reassess the channel and to possibly unblock the channel if interference on that channel is below the predefined energy threshold. In one embodiment, all blocked channels are assigned a value of 1 and all unblocked channels are assigned a value of 0, as can be seen in table 200 of FIG. 2. Channels that have been blocked without actually visiting them are assigned a “do not revisit” (DNR) tag which indicates that these channels are not to be revisited. The reason is that there is no need to revisit these channels since these channels may be automatically unblocked if the channel f at the center of these channels is unblocked when it is revisited.

At block 112 a sequence of operations is performed if at 106 it is determined the source of interference is a microwave oven operating in the 2.4 GHz frequency band. The particular operations that are performed at block 112 are based on the operating characteristics of microwave ovens operating in the 2.4 GHz band. Generally, it has been found that microwave ovens operating in this band operate at a 50% duty factor. Further, the timing is such that interference may be present then absent for several seconds. The spectral spread of microwave ovens emissions can be wide and unpredictable with large frequency drift over time. Thus, when a microwave oven signal is detected, on a particular Bluetooth channel, other Bluetooth channels located a certain distance from the particular Bluetooth channel are automatically blocked. This is because interference from the microwave oven is also expected on these channels because of the large frequency drift over time of the microwave oven's signal. In one embodiment, it is assumed that microwave oven's signals will drift within a L MHz band, which in one embodiment is set at 10 MHz. Thus, if for example, a microwave oven's signal is detected on Bluetooth channel 13 then all channels located 10/2 MHz channels away from this channel will automatically be blocked. Thus, channels 8 to 18 will automatically be blocked. In one embodiment, a revisit delay, for microwave oven signals is set at 0.25 seconds. Further, all channels located within a range of L/2 MHz from the channel mapped to the sequence number n on which microwave oven interference was detected are marked with a “do not revisit” (DNR) tag. As in the case of the 802.11b signals, the theory here is that these channels located L/2 MHz away from the channel on which microwave oven interference was detected are automatically blocked without having to visit them because microwave drift over time will be present in these channels and further they do not need to be revisited since they may be unblocked by revisiting and reassessing the channel on which microwave oven interference was detected in the first place.

In one embodiment, and as an optimization to increase the number of Bluetooth channels that may be used simultaneously in the presence of an interfering microwave oven in the 2.4 GHz band, the “on” time of the microwave oven is tracked. This allows the Bluetooth channels on which there is microwave oven interference to be blocked only during those periods that the microwave oven is actually transmitting interference. Since a microwave oven generally has a duty cycle of 50% this means that microwave oven signals will be detected on a Bluetooth channel in a pattern in which the signal is on 50% of the time and off 50% of the time. Thus, by being able to track the “on” time, these channels do not need to be blocked completely but rather they are blocked only for a limited duration. This makes it possible to still use these channels during periods of the microwave oven duty cycle where there is no interference.

If at block 106 the origin of the interference is found to be a cordless telephone operating in the 2.4 GHz band, then block 114 is executed. Generally cordless telephones operating in the 2.4 GHz band use a narrow band frequency modulation (FM) or digital FM modulation, or a direct sequence modulation technique. In some cases time division duplex and time division multiple access techniques may be used. In other cases, frequency division techniques may be used with one link in the 2.4 GHz band and another located in the 900 MHz ISM band. The center frequencies of cordless telephones are usually fixed. Thus, in one embodiment of the present invention, a sequential search of the entire 2.4 GHz band is performed to find these cordless device emissions. Once located, the channels on which the emissions were located are avoided. These channels are stored in memory and checked on a regular basis. Thus, the operations at block 114 include firstly blocking the Bluetooth channel corresponding to the sequence number n for which the interference was received, and secondly setting a revisit delay period P, after which the channel corresponding to the sequence number n that was just blocked is revisited, to reassess the channel and to possibly unblock it. In one embodiment P is set equal to value 1 second.

After execution of blocks 110, 112 and 114, block 116 is executed wherein a next sequence number n is obtained from the table 200. After execution of block 116, block 102 is re-executed.

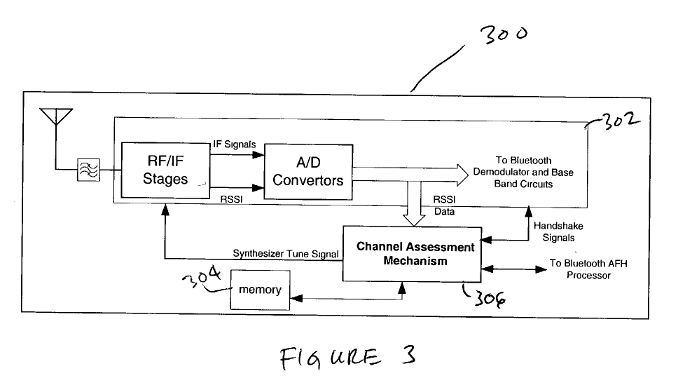

FIG. 3 of the drawings shows a high level block diagram of one embodiment of a Bluetooth receiver that may be used to perform the channel assessment technique described above. As will be seen, the receiver 300 includes a receiver section 302 which can be tuned to receive signals on the Bluetooth channel frequencies. Components of the receiver section 302 include a radio frequency (RF) and an intermediate frequency (IF) stage, analog to digital (A/D) converters, etc. The exact components that make up receiver section 302 have not been shown as these will be known to one skilled in the art. The receiver 300 further includes a memory 304 which stores a predefined sequence, such as the sequence shown in table 200 in FIG. 2 of the drawings, in which the receiver section is to be tuned to the predefined communications channel. Further, the receiver 300 includes a channel assessment mechanism 306 to perform a channel assessment of the predefined communications channels in a manner described above. The channel assessment mechanism may be implemented in hardware, software or in firmware, in accordance with different embodiments of the invention.

Execution of the operations shown in FIG. 1 of the drawings provides a rapid mechanism to assess each of the 79 Bluetooth channels to identify good channels with acceptable interference levels and bad channels with unacceptable interference levels. Bad channels are blocked so that they are unavailable for channel hopping. A particular advantage of the operations shown in FIG. 2 of the drawings is that instead of performing an exhaustive search of all 79 Bluetooth channels, knowledge of specific types of interferers operating in the 2.4 GHz band is used in order to tailor the channel assessment technique to rapidly locate the specific interferers. The rapid evaluation of the Bluetooth spectrum translates to fewer packet collisions and thus lower packet error rates for Bluetooth and the interfered/interfering technologies.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method comprising:
performing a channel assessment of predefined communications channels each centered on a particular frequency within a frequency band, the channel assessment comprising determining if interference on each predefined channel is above a predefined energy threshold, wherein the predefined communications channels are visited in a predefined sequence in which those channels in which interference from specific types of interferers known to operate in the frequency band is likely are visited first; and
disabling those communications channels on which interference above the predefined energy threshold is detected.

2. The method of claim 1, wherein the frequency band is the 2.4 GHz band.

3. The method of claim 1, wherein the specific types of interferers are selected from the group consisting of 802.11x transmitters, microwave ovens, and cordless telephones.

4. The method of claim 1, wherein the predefined communications channels comprise the communications channels of the communications protocol known as Bluetooth.

5. The method of claim 3, further comprising classifying interference above the predefined threshold as being from a specific type of interferer.

6. The method of claim 1, wherein the predefined energy threshold is a number based on a sensitivity of a transceiver used to perform the channel assessment.

7. The method of claim 1, wherein the predefined sequence comprises first tuning to the predefined channel center frequencies that are also channel center frequencies for an 802.11x compliant transceiver.

8. The method of claim 7, wherein if interference above the predefined threshold is detected from an 802.11x compliant transceiver on a particular predefined channel then the disabling comprises disabling those predefined channels that have a center frequency within a frequency band centered on a predefined channel and K MHz wide without visiting those predefined channels.

9. The method of claim 8, wherein K is 22 MHz.

10. The method of claim 6, wherein if interference above the predefined threshold is detected from a microwave oven on a particular predefined channel, then the disabling comprises disabling those predefined channels that have a center frequency within a frequency band centered on the predefined channel and L MH wide, without visiting those predefined channels.

11. The method of claim 10, wherein L is 10 MHz.

12. The method of claim 1, further comprising revisiting a disabled communications channel after a predetermined delay in order to reassess the channel.

13. The method of claim 12, further comprising enabling a disabled communications channel if it no longer has interference above the predefined energy threshold.

14. The method of claim 12, wherein only those disabled channels that were visited before being disabled are revisited.

15. The method of claim 5, further comprising measuring a duty cycle of microwave oven interference, the disabling then comprising disabling only during on periods in the duty cycle.

16. A receiver comprising:
a receiver section to receive signals on predefined communications channels, each centered on a particular frequency within a frequency band;
a memory to store a predefined sequence in which the receiver section is to be tuned to the predefined communications channels; and
a channel assessment mechanism to perform a channel assessment of the predefined communications channels, the channel assessment comprising determining if interference on each predefined communications channel is above a predefined energy threshold, wherein the predefined communications channels are visited in the predefined sequence.

17. The receiver of claim 1, wherein the predefined sequence comprises those predefined channels in which specific types of interferers known to operate in the frequency band is likely are visited first.

18. The receiver of claim 16, wherein the channel assessment mechanism further comprises a channel disabling mechanism to disable those communications channels on which interference above the predefined energy threshold is detected.

19. The receiver of claim 16, wherein the frequency band is a 2.4 GHz band.

20. A system comprising:
means for performing a channel assessment of predefined communications channels, each centered on a particular frequency within a frequency band, the channel assessment comprising determining if interference on each predefined channel is above a predefined energy threshold, wherein the predefined communications channels are visited in a predefined sequence in which those predefined channels in which interference from specific types of interferers known to operate in the frequency band is likely are visited first; and
means for disabling those communications channels on which interference above the predefined energy threshold is detected.

21. The system of claim 20, wherein is a 2.4 GHz band.
